(19) United States
(12) Patent Application Publication
(10) Pub. No.: US 2026/0161529 A1
(43) Pub. Date: Jun. 11, 2026

(54) ORCHESTRATED CONTROL OF EXPLORATION OF A GAME AND/OR A SIMULATION STATE SPACE FOR BALANCING AND TESTING GAME AND/OR SIMULATION PARAMETERS TO OPTIMIZE USER EXPERIENCE

(71) Applicants: Rafal Tyl, Warsaw (PL); Maciej Swiechowski, Otwock (PL); Dominik Slezak, Warsaw (PL)

(72) Inventors: Rafal Tyl, Warsaw (PL); Maciej Swiechowski, Otwock (PL); Dominik Slezak, Warsaw (PL)

(21) Appl. No.: 18/976,393

(22) Filed: Dec. 11, 2024

(51) Int. Cl. G06F 11/3604

(52) U.S. Cl. CPC G06F 11/3616

(57) ABSTRACT

A method, a system and/or a device for orchestrated control of exploration of a game and/or simulation state space for balancing and testing game and/or simulation parameters to optimize user experience is disclosed. In accordance therewith, a number of game and/or simulation parameters associated with a gaming/simulation environment are initialized and/or refined based on executing a binary executable and/or a game and/or a simulation multiple times. Exploration of a space associated with the number of game and/or simulation states by a number of agents is automatically controlled in accordance with determining a game/simulation path for one or more of the number of agents to explore. User experience of the gaming/simulation environment is optimized in accordance with iteratively balancing parameters related to specific configurations of the gaming/simulation environment.

### FIELD OF TECHNOLOGY

This disclosure relates generally to gaming/simulation systems and, particularly, to a method, a system and/or a device for orchestrated control of exploration of a game and/or simulation state space for balancing and testing game and/or simulation parameters to optimize user experience.

### BACKGROUND

Automated testing of a game and/or a simulation may involve triggering constituent tests thereof at appropriate milestones of software development associated therewith. The game and/or the simulation may have a number of states associated therewith. A user of a gaming/simulation platform executing the game and/or the simulation may not even encounter many of the states during gaming experience thereof. At the other end, the user may find a current mode of the game and/or the simulation way too easy (or too hard) with respect to completion of requirements thereof. By not capturing complexities of the gaming/simulation environment, the aforementioned automated testing may fail to do enough to sustain interest of users with regard to the game and/or the simulation.

### SUMMARY

Disclosed are a method, a system and/or a device for orchestrated control of exploration of a game and/or simulation state space for balancing and testing game and/or simulation parameters to optimize user experience.

In one aspect, a method of a data processing device executing one or more gaming and/or simulation algorithms via a processor thereof communicatively coupled to a memory is disclosed. The method includes initializing and/or refining a number of game and/or simulation states associated with a virtual environment offered by a gaming and/or simulation application in accordance with executing a binary executable and/or a game and/or simulation associated with the gaming and/or simulation application multiple times. The initialization and/or the refinement utilizes configuration information associated with the game and/or the simulation therefor.

The method also includes automatically controlling exploration of a space associated with the number of game and/or simulation states by a number of agents interacting with the virtual environment in accordance with determining, for one or more of the number of agents to explore, a path including a sequence of at least a subset of the number of game and/or simulation states with a maximum sum of distances between constituent game and/or simulation states of at least the subset and corresponding closest game and/or simulation states of the number of game and/or simulation states, and/or a maximized sum of novelty scores associated with the constituent game and/or simulation states of at least the subset.

Further, the method includes optimizing user experience of the virtual environment associated with the gaming and/or simulation application across a number of users in accordance with iteratively balancing parameters related to specific configurations of the virtual environment associated with the gaming and/or simulation application based on full simulations of the game and/or simulation by the number of agents. The parameters are related to at least some of the number of game and/or simulation states.

In another aspect, a data processing device including a memory including instructions associated with one or more gaming and/or simulation algorithms stored therein, and a processor communicatively coupled to the memory to execute the instructions associated with the one or more gaming and/or simulation algorithms stored in the memory is disclosed. The processor executes the instructions associated with the one or more gaming and/or simulation algorithms to initialize and/or refine a number of game and/or simulation states associated with a virtual environment offered by a gaming and/or simulation application in accordance with executing a binary executable and/or a game and/or simulation associated with the gaming and/or simulation application multiple times. The initialization and/or the refinement utilizes configuration information associated with the game and/or the simulation therefor.

The processor also executes the instructions associated with the one or more gaming and/or simulation algorithms to automatically control exploration of a space associated with the number of game and/or simulation states by a number of agents interacting with the virtual environment in accordance with determining, for one or more of the number of agents to explore, a path including a sequence of at least a subset of the number of game and/or simulation states with a maximum sum of distances between constituent game and/or simulation states of at least the subset and corresponding closest game and/or simulation states of the number of game and/or simulation states, and/or a maximized sum of novelty scores associated with the constituent game and/or simulation states of at least the subset.

Further, the processor executes the instructions associated with the one or more gaming and/or simulation algorithms to optimize user experience of the virtual environment associated with the gaming and/or simulation application across a number of users in accordance with iteratively balancing parameters related to specific configurations of the virtual environment associated with the gaming and/or simulation application based on full simulations of the game and/or simulation by the number of agents. The parameters are to at least some of the number of game and/or simulation states.

In yet another aspect, a computing system including a data processing device including instructions associated with one or more gaming and/or simulation algorithms stored therein, and one or more other data processing devices communicatively coupled to the data processing device is disclosed. The data processing device executes the instructions associated with the one or more gaming and/or simulation algorithms to initialize and/or refine a number of game and/or simulation states associated with a virtual environment offered by a gaming and/or simulation application in accordance with executing a binary executable and/or a game and/or simulation associated with the gaming and/or simulation application multiple times. The initialization and/or the refinement utilizes configuration information associated with the game and/or the simulation therefor.

The data processing device also executes the instructions associated with the one or more gaming and/or simulation algorithms to automatically control exploration of a space associated with the number of game and/or simulation states by a number of agents interacting with the virtual environment in accordance with determining, for one or more of the number of agents to explore, a path including a sequence of at least a subset of the number of game and/or simulation states with a maximum sum of distances between constituent game and/or simulation states of at least the subset and corresponding closest game and/or simulation states of the number of game and/or simulation states, and/or a maximized sum of novelty scores associated with the constituent game and/or simulation states of at least the subset.

Further, the data processing device executes instructions associated with the one or more gaming and/or simulation algorithms to optimize user experience of the virtual environment associated with the gaming and/or simulation application across a number of users in accordance with iteratively balancing parameters related to specific configurations of the virtual environment associated with the gaming and/or simulation application based on full simulations of the game and/or simulation by the number of agents. The parameters are related to at least some of the number of game and/or simulation states.

The methods and systems disclosed herein may be implemented in any means for achieving various aspects, and may be executed in a form of a machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of accompanying drawings, in which like references indicate similar elements and in which:

FIG. 1 is a schematic view of a virtual data processing environment, according to one or more embodiments.

FIG. 2 is a schematic view of a data processing device of FIG. 1 offering a gaming/simulation platform based on execution of a gaming/simulation platform engine thereon, according to one or embodiments.

FIG. 3 is an illustrative pictorial view of test orchestration performed through the data processing device and the virtual data processing environment of FIGS. 1-2, according to one or more embodiments.

FIG. 4 is a schematic view of access of a game-state space by the gaming/simulation platform engine of FIG. 2 for game-space exploration, according to one or more embodiments.

FIG. 5 is a schematic view of exploration by parameter maximization employed by an exploration algorithm of FIG. 4, according to one or more embodiments.

FIG. 6 is a schematic view of parameter balancing performed through the gaming/simulation platform engine of FIG. 2, according to one or more embodiments.

FIG. 7 is a process flow diagram detailing the operations involved in orchestrated control of exploration of a game and/or simulation state space for balancing and testing game and/or simulation parameters to optimize user experience, according to one or more embodiments.

Other features of the present embodiments will be apparent from the accompanying drawings and from the detailed description that follows.

### DETAILED DESCRIPTION

Example embodiments, as described below, may be used to realize orchestrated control of exploration of a game and/or simulation state space for balancing and testing game and/or simulation parameters to optimize user experience. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

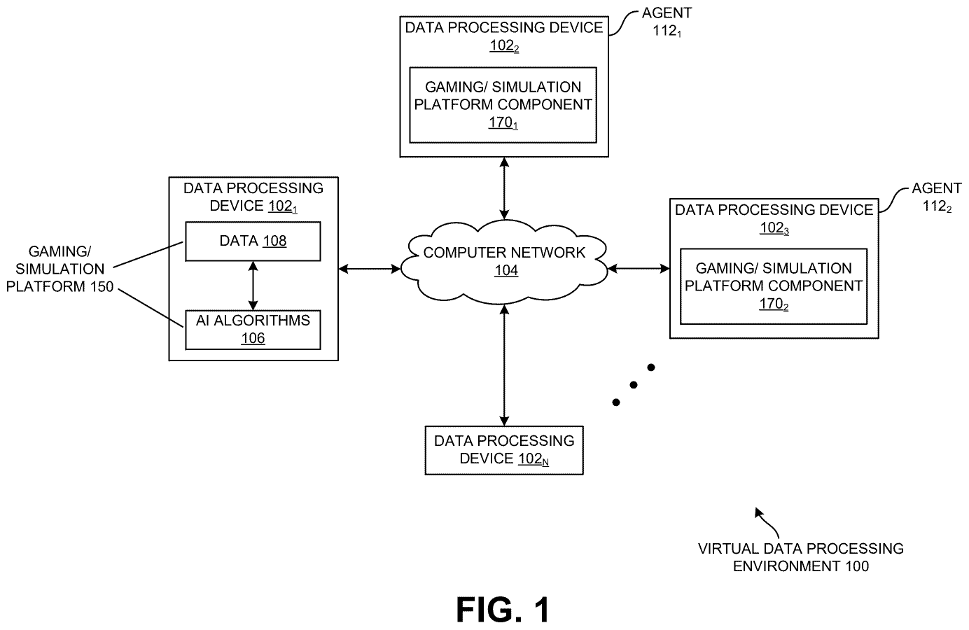

FIG. 1 shows a virtual data processing environment 100, according to one or more embodiments. In one or more embodiments, virtual data processing environment 100 may include a number of data processing devices 102_{1-N} communicatively coupled to one another through a computer network 104 (e.g., a Wide Area Network (WAN), a Local Area Network (LAN), a mobile network, a private network, a short-range communication protocol-based network). In one or more embodiments, one or more data processing device(s) 102_{1-N}(e.g., just data processing device 102₁, as shown in FIG. 1, for the sake of example) may execute one or more AI algorithm(s) 106 thereon on data 108 discussed herein.

In one or more embodiments, data processing device 102₁ may be a server or any other form of data processing device. In FIG. 1, for the sake of example, data processing devices 102_{2-N} may be client devices (e.g., laptops, desktop computers, mobile phones, smart data processing devices, portable smart devices) at which agents may interact with a virtual environment provided via data processing device 102₁. As seen in FIG. 1, in one or more embodiments, data processing device 102₁ may offer a gaming/simulation platform 150 thereon that provides data 108 to AI algorithms 106 (e.g., via a gaming/simulation platform engine 250), as will be discussed herein. While FIG. 1 shows agents 112₁₋₂ at data processing devices 102₂₋₃ merely for the sake of example, it should be noted that multiple agents may execute at the same or many different data processing devices 102_{2-N}.

In one or more embodiments, each data processing device 102₂₋₃ may execute a component of gaming/simulation platform 150 as gaming/simulation platform component 170₁₋₂. It should be noted that data processing device 102₂₋₃ may also offer a virtual machine (VM)-based environment in which an abstracted form of a gaming/simulation application (e.g., a gaming/simulation application 270) offered by the underlying physical hardware (e.g., data processing device 102₁) may be executed. All reasonable variations are within the scope of the exemplary embodiments discussed herein.

In one or more embodiments, gaming/simulation platform 150 may enable automatic testing using agents 112₁₋₂ (or more agents) with specific methods/processes for guiding gaming/simulation space exploration. In one or more embodiments, the aforementioned methods/processes may be broken down into: (i) test orchestration, (ii) gaming/simulation space exploration, and (ii) parameter balancing. In one or more embodiments, gaming/simulation platform 150, as part of test orchestration, may execute multiple game instances (e.g., in parallel) and manipulate at least some in-game parameters, as will be discussed below.

In one or more embodiments, test orchestration, as discussed herein, may ensure that multiple automatic tests associated with a gaming/simulation application, including tests associated with environments of execution thereof, executed on gaming/simulation platform 150 are organized in a specific sequence efficiently. In one or more embodiments, the test orchestration discussed herein may be integrated with developmental operations associated with gaming/simulation applications so that these automatic tests are triggered by events in the delivery pipelines. For example, even completion of a new gaming/simulation application software build may trigger one or more automated tests as part of the test orchestration discussed herein.

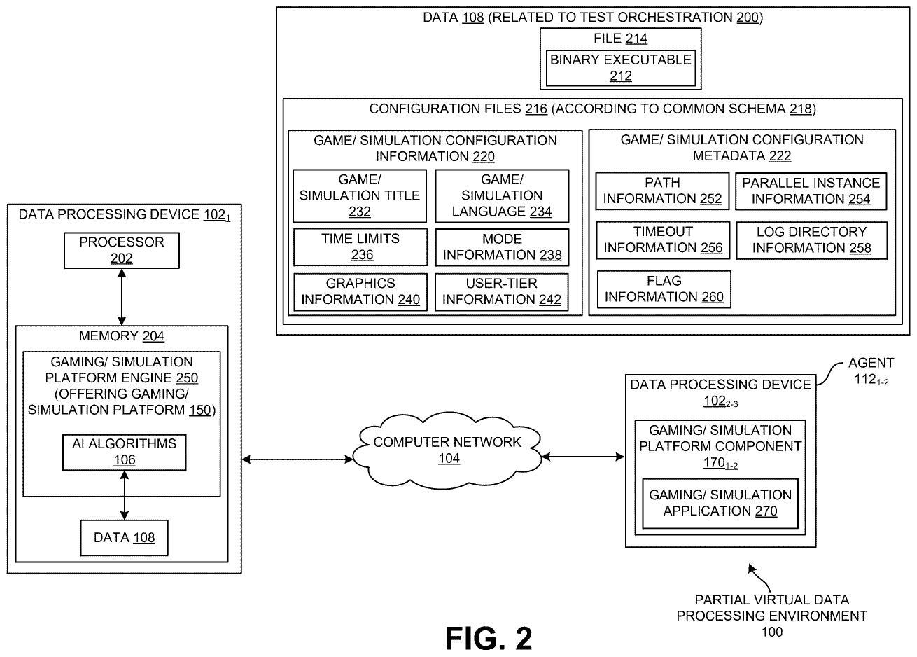

FIG. 2 shows data processing device 1021 offering gaming/simulation platform 150 based on execution of a gaming/simulation platform engine 250 thereon, according to one or embodiments. In one or more embodiments, data processing device 1021 may include a processor 202 (e.g., a standalone processor, a network/cluster of processors, a number of processor cores) communicatively coupled to a memory 204 (e.g., a volatile and/or a non-volatile memory) in which gaming/simulation platform engine 250 may be stored for execution through processor 202. In one or more embodiments, AI algorithms 106 may be part of gaming/simulation platform engine 250 in memory 204; gaming/utility platform engine 250, by way of AI algorithms 106, may utilize data 108 stored in memory 204 for purposes of execution. In one or more embodiments, the results of the execution(s) discussed herein may also be considered as part of data 108.

In one or more embodiments, as discussed above, gaming/simulation platform 150 may be game/simulation-agnostic, and gaming/simulation platform engine 250 may execute multiple game instances (e.g., in parallel) and manipulate at least some in-game/simulation parameters. FIG. 2 shows data 108 relevant to test orchestration 200, according to one or more embodiments. In one or more embodiments, in accordance with test orchestration 200, a binary executable 212 of gaming/simulation application 270 may be generated through gaming/simulation platform engine 250 (and/or one or more of gaming/simulation platform components 170₁₋₂). For the aforementioned purpose, code associated with gaming/simulation application 270 in a high-level language (e.g., C++) may be compiled into one or more object files and linked with libraries if required and/or supplemental object code as binary executable 212. Generation of binary executables are known to one skilled in the art. Detailed discussion thereof has, therefore, been skipped for the sake of clarity and focus.

In one or more embodiments, gaming/simulation platform engine 250 may execute binary executable 212 or a file 214 including binary executable 212. In one or more embodiments, the aforementioned execution may utilize configuration files 216 prepared according to a common schema 218; in other words, common schema 218 may represent the same schema regardless of gaming/simulation application 270 whose binary executable 212 is executed. As known to one skilled in the art, schema of configuration files may be elements that serve as blueprints that define structure and behavior of configuration files 216.

In one or more embodiments, configuration files 216 (e.g., in a JavaScript Object Notation (JSON) format) may include game/simulation configuration information 220 and game/simulation configuration metadata 222. Examples of game/simulation configuration information 220 may include but are not limited to game/simulation title 232, game/simulation language 234, time limits 236, mode (single-player/multi-player) information 238, graphics information 240 including layout information, and user-tier information 242. Examples of game/simulation configuration metadata 222 may include but are not limited to path information 252 that relates to a path to binary executable 212 and a path to game/simulation configuration information 220, parallel instance information 254 (e.g., a number of parallel instances to be executed, with the default value being 1), timeout information 256 relating to a time period following which a game/simulation process is to be forcefully terminated (e.g., 120 seconds, 300 seconds; in some implementations, the timeout itself may be disabled by specifying a value of −1 as part of timeout information 256), log directory information 258 that includes a path to a folder in which logs of events is stored, and flag information 260 which potentially may include a flag denoting whether gaming/simulation platform engine 250 itself should log messages thereof to a file in addition to outputting said messages for standardized reception.

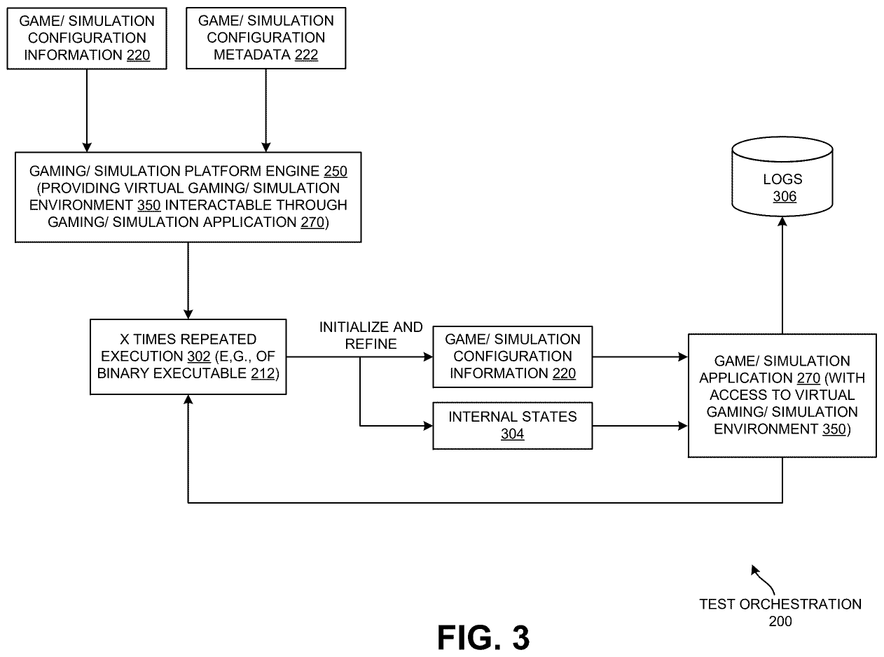

FIG. 3 shows a pictorial representation of test orchestration 200, according to one or more embodiments. As seen in FIG. 3, gaming/simulation platform engine 250 may take game/simulation configuration information 220 and game/simulation configuration metadata 222 as inputs thereto and execute multiple instances of gaming/simulation application 270/binary executable 212 (e.g., using gaming/simulation platform engine 250 and/or one or more data processing devices102_{2-N} including data processing devices 102₂₋₃ executing gaming/simulation platform components 170₁₋₂), for example, in parallel. In FIG. 3, the aforementioned multiple instances of execution are indicated as X times repeated execution 302. In one or more embodiments, based on the aforementioned execution, internal states 304 (e.g., contexts internal to gaming/simulation application 270 and encounterable during user interaction with a virtual gaming/simulation environment 350 (“game” or “simulation” in common parlance) provided through gaming/simulation platform engine 250) of gaming/simulation application 270 may be initialized in conjunction with game/simulation configuration information 220.

In one or more embodiments, in accordance with initialized internal states 304 and game/simulation configuration information 220, gaming/simulation application 270 may also be executed and logs (e.g., results, events) 306 related to the aforementioned execution generated. In one or more embodiments, a game (e.g., a full game) pertaining to gaming/simulation application 270 may also be executed multiple times (e.g., also X times, as shown in FIG. 3), based on which initialized states 304 and game/simulation configuration information 220 may be refined (e.g., through analyses of logs 306). It should be noted that all data generated, used and/or stored may be regarded as part of data 108 unless specifically mentioned otherwise and stored in memory 204 (or, memories of data processing devices 102_{1-N} to be accessed by gaming/simulation platform engine 250).

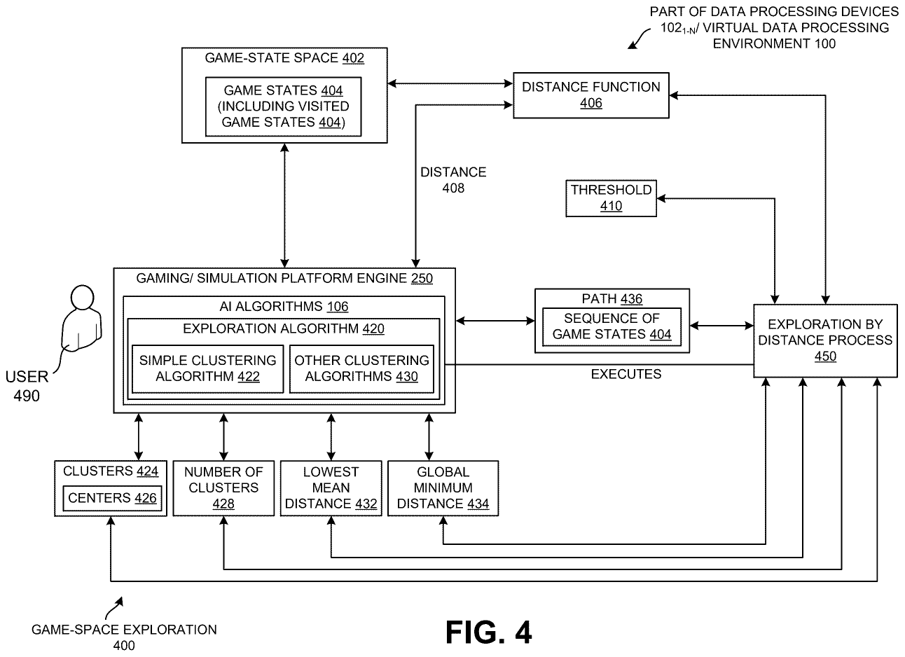

In one or more embodiments, as discussed above, gaming/simulation platform engine 250 may allow control of agents (e.g., agents 112₁₋₂; bots serving as virtual players) interacting with gaming/simulation application 270) in virtual gaming/simulation environment 350 by making said agents explore a space associated with game states. FIG. 4 shows a game-state space 402 including game states 404 (e.g., part of memory 204; internal states 304) of gaming/simulation application 270 accessed by gaming/simulation platform engine 250 for game-space exploration 400, according to one or more embodiments. It should be noted that while there may be one or more methods of controlling agents to explore game-state space 402, each method may be switched on or off through gaming/simulation platform engine 250 based on dynamically determined requirements.

In one or more implementations, game-space exploration 400 may involve employment of an exploration by distance process 450 that involves a distance function 406 that takes two game states 404 as arguments and returns a distance 408 between said two game states 404. Distance 408 may then be used for purposes of maximum exploration. A threshold 410 that controls switching to clusters of game states 404 from atomic game states 404 may also be utilized in exploration by distance process 450. In one or more embodiments, gaming/simulation platform engine 250 may implement an exploration algorithm 420 (e.g., as part of AI algorithms 106) to track game states 404 visited (e.g., by agents 112₁₋₂) during interactions with virtual gaming/simulation environment 350 in accordance with execution of gaming/simulation application 270. In one or more embodiments, if a number of stored visited game states 404 reaches threshold 410, exploration algorithm 420 may perform simple clustering (e.g., partition-based, centroid-based; simple clustering algorithm 422 is shown as part of exploration algorithm 420) thereon and store only visited game states 404 that are centers (e.g., centers 426) of the clusters (e.g., clusters 424) created.

In one or more embodiments, a number of clusters 428 created during clustering (e.g., as a result of execution of simple clustering algorithm 422 or other clustering algorithms 430) may be another argument employed by exploration by distance process 450. In one or more embodiments, distance 408, threshold 410 and number of clusters 428 may be supplied by a user 490 of gaming/simulation platform engine 250. In one or more embodiments, user 490 may start from default values of the aforementioned parameters (e.g., distance 408, threshold 410, number of clusters 428) and perform tweaking thereof based on observed performances with agents 112₁₋₂.

In one or more embodiments, clustering performed by exploration algorithm 420 may involve representing a cluster 424 by a representative game state 404 and a minimum distance (e.g., distance 408, another distance) thereof to another cluster 424; the aforementioned distance may be termed escape distance, analogous to escape velocity. In one or more embodiments, when a current number of visited game states 404 exceeds threshold 410, the clustering may begin. In one or more embodiments, clusters 424 (or, representative game states 404) may subsequently be removed by combining two currently closest clusters 424. In one or more embodiments, if multiple clusters 424 share a closest neighboring cluster 424, the one with a lowest mean distance 432 to other clusters 424 may be removed. In one or more embodiments, if more than one cluster 424 still shares closest neighboring cluster 424, removal of a cluster 424 therefrom may be randomly done.

In one or more embodiments, the process discussed above may stop when a current number of remaining clusters 424 (or, representative game states 404) is equal to number of clusters 428 chosen as less than threshold 410 and/or when the current number of remaining clusters 424 is less than threshold 410. In one or more embodiments, a global minimum distance 434 between two remaining clusters 424 may then be computed. In one or more embodiments, during clustering, exploration algorithm 420 may not add a new game state 404 or cluster 424 if an existing game state 404 (or cluster 424) is closer to any existing cluster 424 than global minimum distance 434.

In one or more embodiments, exploration by distance process 450 may utilize currently considered (or available) paths in game-state space 402, and return a path for an agent 112₁₋₂/user to follow. In one or more embodiments, a path may be a sequence of game states 404 starting from there being merely one game state 404 in the sequence to there being many game states 404 therein. To summarize, in one or more embodiments, exploration by distance process 450 may involve computing, for each game state 404 Sᵢ in a path 436, a distance (e.g., distance 408) to a closest game state 404 among a set of defined and visited game states 404 stored and subsequent game states 404 S_{J}, j>i on path 436. In one or more embodiments, each path 436 may be assigned a score that is a sum of distances (e.g., distance 408) computed in accordance with the discussion above. In one or more embodiments, path 436 with the highest score may be chosen for exploration by agents 112₁₋₂.

In one or more embodiments, game-space exploration 400 may also involve exploration by parameter maximization. Here, exploration algorithm 420 may accept a game state 404 and return a hashed set of parameters. In one or more embodiments, the idea here is that game states 404 represent gaming experiences to collect and/or test. Example parameters (e.g., parameters 502_{1-K}, as will be seen below) may include but are not limited to a flag that a specific event occurred (e.g., based on logs 306), reaching a specific location, obtaining a score greater than a threshold, recruiting a specific unit and opening a specific door over the course of a gaming experience/interaction with virtual gaming/simulation environment 350 associated with gaming/simulation application 270.

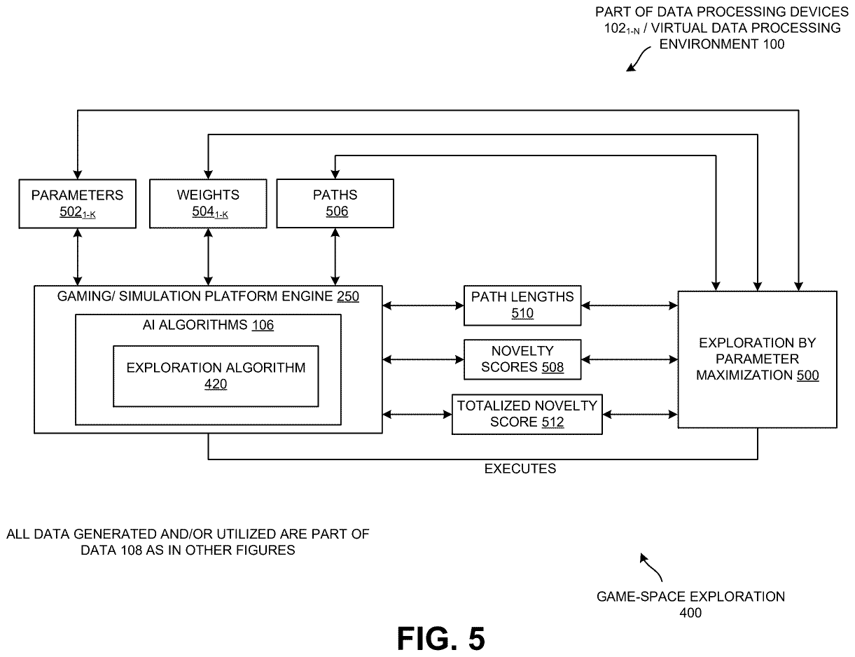

FIG. 5 shows exploration by parameter maximization 500 (also, game-space exploration 400) being employed by exploration algorithm 420, according to one or more embodiments. In one or more embodiments, the parameters discussed above may be represented as parameters502_{1-K} (e.g., part of data 108); each parameter 502_{1-K} may have a weight (e.g., part of weights 504_{1-K}) associated therewith, which represents a novelty magnitude thereof. Here, in one or more embodiments, user 490 may provide available paths 506 (e.g., sequences of game states 404) for agent 112₁₋₂ to traverse. In one or more embodiments, exploration algorithm 420/gaming/simulation platform engine 250 may compute a novelty score (e.g., part of novelty scores 508) for each path 506. In one or more embodiments, each novelty score 508 may be normalized through division thereof by a corresponding path length (e.g., part of path lengths 510; a path length may be the length of path 506). In one or more embodiments, a totalized novelty score 512 may be computed as the sum of weights 504_{1-K} of new parameters 502_{1-K}. Here, in one or more embodiments, new parameters 502_{1-K} may be parameters 502_{1-K} that have neither been stored yet nor have appeared in previous game states 404 of a considered path 506. The discussion associated herein with regard to new parameters 502_{1-K}/parameters 502_{1-K} may be similar to the discussion with regard to exploration by distance process 450 in that a path 506 with a maximized sum of novelty scores 508 is determined for one or more agents (e.g., including agents 112₁₋₂) to explore.

In one or more embodiments, game-space exploration 400 may further involve exploration by planning by predicting consequences of each action (e.g., interaction with virtual/gaming environment 350) based on reasoning and intermediate paths (e.g., paths 506, path 436) to reach a set of parameters (e.g., parameters 502_{1-K}) associated with a target goal.

In one or more embodiments, gaming/simulation platform engine 250 may also execute a parameter balancing process to calculate a balance of a specific gaming configuration. In one or more embodiments, balance, as discussed herein, may refer to a parameter or a set of parameters representing optimality of match of gaming experience across a number of users (e.g., including user 490) during interaction thereof with virtual gaming/simulation environment 350. As part of gaming parameter balancing, in one or more embodiments, gaming/simulation platform engine 250 may adjust parameters 502_{1-K} (and, optionally, even game/simulation configuration information 220) associated with gaming/simulation application 270 to ensure that factors including but not limited to environment customization, a difficulty level, pacing, win-loss conditions, game states 404 (e.g., may be related to parameters 502_{1-K}), fairness, resource consumption and even overall experience are optimized across the number of users.

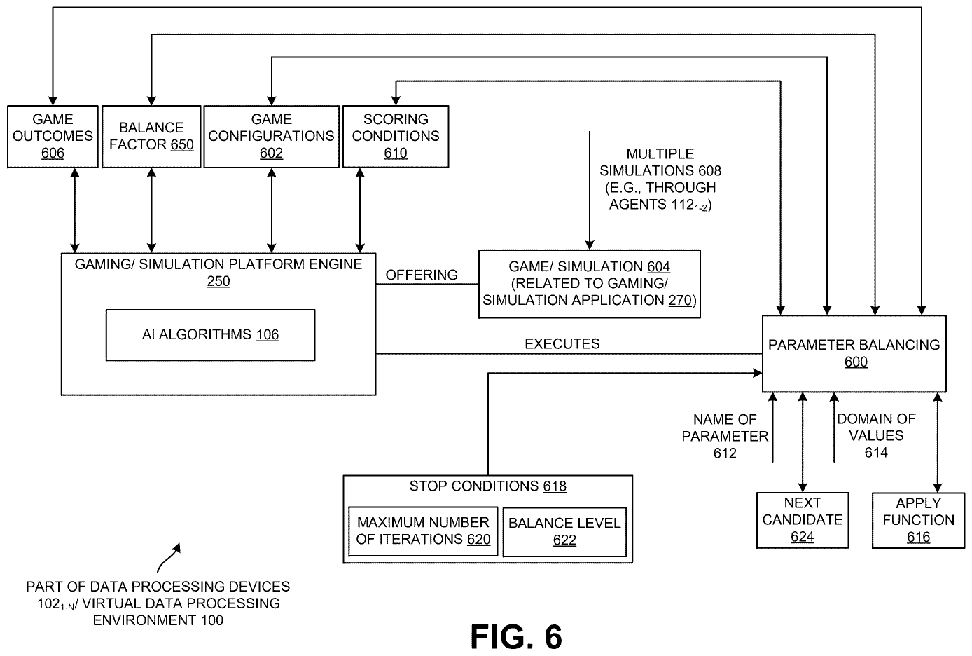

FIG. 6 shows parameter balancing 600 performed through gaming/simulation platform engine 250, according to one or more embodiments. In one or more embodiments in accordance with parameter balancing 600, a balance factor 650 of a given game configuration 602 (e.g., associated with gaming/simulation application 270 and/or virtual gaming/simulation environment 350) may be computed empirically using full simulations of a game/simulation 604 related to gaming/simulation application 270; the aforementioned full simulations may only utilize agents (e.g., including agents 112₁₋₂; e.g., bots; Monte Carlo Tree Search (MCTS)-based agents). In one or more embodiments, if

$${se}_{k}^{i} ∈ [ - 1 , 1 ]$$

denotes a game outcome 606 (e.g., represented as values (e.g., numerical)) arrived at by the i^{th} player (agents including agents 112₁₋₂) and

$${se}_{k}^{j} ∈ [ - 1 , 1 ]$$

denotes game outcome 606 arrived at by the j^{th} player (agents) in the k^{th} full game simulation, balance factor 650 may be equal to:

$$1 - \frac{{\sum }_{k}^{R} {\sum }_{i , j , i \neq j} \vert {se}_{k}^{i} - {se}_{k}^{j} \vert}{R * {(}_{2}^{p} )}$$

In one or more embodiments, in the above equation, R denotes a number of simulations, k=1.. R, and p denotes a number of players/agents (e.g., including agents 112₁₋₂). In one or more embodiments, balance factor 650 may be computed for any game configuration 602 (e.g., also related to game/simulation configuration information 220). In accordance with parameter balancing 600, each simulation 608 of game/simulation 604 may involve resetting a current state of simulation 608 to game configuration 602, initializing each player/agent (e.g., including agent 112_{1-N}) as an MCTS player, and performing operations until a scoring condition 610 (e.g., end of the game or a custom trigger, in which the each player/agent is assigned a single numerical value determining game outcome 606).

In one or more embodiments, parameter balancing 600 may be implemented using gaming/simulation platform engine 250 that utilizes the following elements: a name of parameter 612 (e.g., a soldier unit's starting health), a domain of values 614 (e.g., 10, 15, 20, 25, 30), an apply function 616 that modifies game code to apply an effect of a value 614 chosen from domain of values 614. For example, the soldier unit's starting health may be 10. In one or more embodiments, apply function 616 may symbolize a procedural approach required for automated testing of the game; such an approach is unavailable in the context of automated tests. In one or more embodiments, the paradigm shift herein may not only encompass agent-only simulations (e.g., simulation 608), no-rendering mode and altering game clocks, but also encompass encapsulation of game modification logic into code.

In one or more embodiments, parameter balancing 600 may be iterative with two stop conditions 618, viz. a maximum number of iterations 620 and a balance level 622 (e.g., 0.0 implies no balance, 1.0 implies maximum balance); the process may terminate when balance factor 650 is determined to be equal to or greater in the context of balance level 622. In one or more embodiments, parameter balancing 600 may involve setting, for each parameter 502_{1-K} (and all parameters discussed with regard to other figures), a value in accordance with a selecting a best candidate thereof, calculating balance level 622 through agents 112₁₋₂ playing game/games associated with gaming/simulation application 270, and updating statistics and previously chosen values based on newly arrived at values. It is obvious that the aforementioned may be performed until stop conditions 618 are met.

In one or more embodiments, parameter balancing 600 may involve trying out each value of each parameter 502_{1-K} once. In accordance with the selection of the best candidate discussed above, in one or more embodiments, subsequently, a next candidate 624 for the each parameter 502_{1-K} may be determined using a specialized formula rooted in regret minimization theory (e.g., a decision-making/gaming theory framework known to one skilled in the art). In one or more embodiments, the formula is arrived at as a consequence of a trade-off between exploration and exploitation as:

$$v *= {argmax}_{i} B ( {v}_{i} ) + \sqrt{\frac{2 ln ( {n}_{i} )}{N}}$$

In one or more embodiments, v* denotes a value of the selected parameter 502_{1-K}, vᵢ denotes a candidate value for selection, B denotes an average balance coefficient involving the selected parameter 502_{1-K}, which is computed over multiple iterations for which the candidate value vᵢ is set, nᵢ denotes the iterations in which the candidate value vᵢ is selected, N denotes a number of iterations thus far, and argmax is a function that returns the index i at which B(vᵢ) is maximum.

Thus, in one or more embodiments, gaming/simulation platform engine 250 may provide for enhanced exploration of game-state space 402 in an orchestrated manner using agents (e.g., including agents 112₁₋₂), thereby providing for balancing of parameters 502_{1-K} (and other parameters) associated with virtual gaming/simulation environment 350 across users to optimize experience thereof. Although FIG. 1 shows AI algorithms 106 for the sake of scalability implications associated with the exemplary embodiments and the possibility of training one or more constituent algorithms thereof, it should be noted that non-AI algorithms are also within the scope of the exemplary embodiments discussed herein. In one or more embodiments, virtual data processing environment 100 may be network-based, cloud-based and/or hybrid-network based. Further, while certain elements have only game/gaming-related adjectives tagged thereto, it should be noted that all of these elements are also applicable to simulations including but not limited to training simulations. All reasonable variations are within the scope of the exemplary embodiments discussed herein.

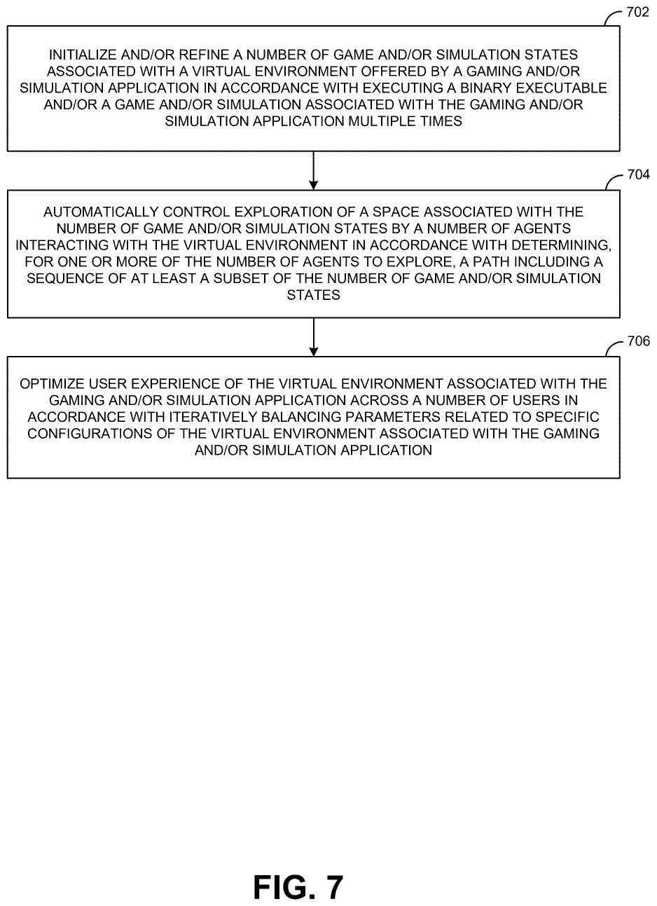

FIG. 7 shows a process flow diagram detailing the operations involved in orchestrated control of exploration of a game and/or simulation state space (e.g., game state space 402) for balancing and testing game and/or simulation parameters to optimize user experience, according to one or more embodiments. In one or more embodiments, the operations may be performed through execution of one or more gaming and/or simulation algorithms (e.g., gaming/simulation platform engine 250, AI algorithms 106, exploration algorithm 420) on a data processing device (e.g., data processing device 1021, data processing devices 102_{2-N}). In one or more embodiments, operation 702 may involve initializing and/or refining a number of game and/or simulation states (e.g., game states 404, internal states 304) associated with a virtual environment (e.g., virtual gaming/simulation environment 350) offering by a gaming and/or simulation application (e.g., gaming/simulation application 270) in accordance with executing a binary executable (e.g., binary executable 212) and/or a game and/or simulation associated with the gaming and/or simulation application multiple times. In one or more embodiments, the initialization and/or the refinement may utilize configuration information (e.g., game/simulation configuration information 220) associated with the game and/or the simulation therefor.

In one or more embodiments, operation 704 may involve automatically controlling exploration of a space (e.g., game-state space 402) associated with the number of game and/or simulation states by a number of agents (e.g., agents 112₁₋₂) interacting with the virtual environment in accordance with determining, for one or more of the number of agents to explore, a path (e.g., path 436, path 506) including a sequence of at least a subset of the number of game and/or simulation states with a maximum sum of distances between constituent game and/or simulation states of at least the subset and corresponding closest game and/or simulation states of the number of game and/or simulation states, and/or a maximized sum of novelty scores associated with the constituent game and/or simulation states of at least the subset.

In one or more embodiments, operation 706 may then involve optimizing user experience of the virtual environment associated with the gaming and/or simulation application across a number of users (e.g., user 490) in accordance with iteratively balancing parameters (e.g., parameters 502_{1-K}) related to specific configurations (e.g., configuration(s) 602) of the virtual environment associated with the gaming and/or simulation application based on full simulations of the game and/or simulation by the number of agents. In one or more embodiments, the parameters may be related to at least some of the number of game and/or simulation states.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., one or more data processing device(s) 102_{1-N}), and may be performed in any order (e.g., including using means for achieving the various operations). Accordingly, the specification and drawings are to be regarded in an illustrative rather than a restrictive sense.

What is claimed is:

1. A method of a data processing device executing at least one gaming and/or simulation algorithm via a processor thereof communicatively coupled to a memory, comprising:
at least one of: initializing and refining a plurality of game and/or simulation states associated with a virtual environment offered by a gaming and/or simulation application in accordance with executing at least one of: a binary executable and a game and/or simulation associated with the gaming and/or simulation application multiple times, the at least one of: the initialization and the refinement utilizing configuration information associated with the game and/or the simulation therefor;
automatically controlling exploration of a space associated with the plurality of game and/or simulation states by a plurality of agents interacting with the virtual environment in accordance with determining, for at least one of the plurality of agents to explore, a path comprising a sequence of at least a subset of the plurality of game and/or simulation states with at least one of: a maximum sum of distances between constituent game and/or simulation states of at least the subset and corresponding closest game and/or simulation states of the plurality of game and/or simulation states, and a maximized sum of novelty scores associated with the constituent game and/or simulation states of at least the subset; and
optimizing user experience of the virtual environment associated with the gaming and/or simulation application across a plurality of users in accordance with iteratively balancing parameters related to specific configurations of the virtual environment associated with the gaming and/or simulation application based on full simulations of the game and/or simulation by the plurality of agents, the parameters related to at least some of the plurality of game and/or simulation states.

2. The method of claim 1, further comprising, for each constituent game and/or simulation state in each path sequence formed with the plurality of game and/or simulation states comprising the path with the maximum sum of distances,
calculating a distance to a closest game and/or simulation state of the plurality of game and/or simulation states among a set of game and/or simulation states already defined and stored in the memory and subsequent constituent game and/or simulation states in the each path sequence; and
scoring the each path sequence with each of the calculated distance to the closest game and/or simulation state summed for all constituent game and/or simulation states therein.

3. The method of claim 2, comprising:
performing clustering of all the constituent game and/or simulation states for the each path sequence such that each cluster is represented by a representative of the constituent game and/or simulation states and a minimum distance thereof to another cluster; and
determining a global minimum distance between two clusters generated through the clustering.

4. The method of claim 1, comprising computing, as part of iteratively balancing the parameters, a balance factor of a configuration of the specific configurations as
$$1 - \frac{{\sum }_{k}^{R} {\sum }_{i , j , i \neq j} \vert {se}_{k}^{i} - {se}_{k}^{j} \vert}{R * {(}_{2}^{p} )} ,$$
wherein R denotes a number of the full simulations of the game and/or simulation, k=1.. R, p denotes a number of the plurality of agents, and
$${se}_{k}^{i} ∈ [ - 1 , 1 ] and {se}_{k}^{j} ∈ [ - 1 , 1 ]$$
denote game outcomes arrived at by the i^{th} and the j^{th} agent in the k^{th} full simulation.

5. The method of claim 1, further comprising determining, as part of iteratively balancing the parameters, a candidate for a next parameter of each parameter of the parameters in accordance with
$$v *= {argmax}_{i} B ( {v}_{i} ) + \sqrt{\frac{2 ln ( {n}_{i} )}{N}} ,$$
wherein v* denotes a value of the each parameter, vᵢ denotes a candidate value for selection, B denotes an average balance coefficient involving the each parameter, which is computed over multiple iterations for which the candidate value vᵢ is set, nᵢ denotes the iterations in which the candidate value vᵢ is selected, N denotes a number of iterations thus far, and argmax is a function that returns the index i at which B(vᵢ) is maximum.

6. The method of claim 1, comprising the data processing device executing at least one of: an Artificial Intelligence (AI) algorithm, a clustering algorithm and a non-AI algorithm as the at least one gaming and/or simulation algorithm.

7. The method of claim 1, comprising the plurality of agents executing the full simulations of the game and/or the simulation on at least one of: the data processing device and at least one other data processing device communicatively coupled to the data processing device through a computer network.

8. A data processing device comprising:
a memory comprising instructions associated with at least one gaming and/or simulation algorithm stored therein; and
a processor communicatively coupled to the memory to execute the instructions associated with the at least one gaming and/or simulation algorithm stored in the memory to:
at least one of: initialize and refine a plurality of game and/or simulation states associated with a virtual environment offered by a gaming and/or simulation application in accordance with executing at least one of: a binary executable and a game and/or simulation associated with the gaming and/or simulation application multiple times, the at least one of: the initialization and the refinement utilizing configuration information associated with the game and/or the simulation therefor,
automatically control exploration of a space associated with the plurality of game and/or simulation states by a plurality of agents interacting with the virtual environment in accordance with determining, for at least one of the plurality of agents to explore, a path comprising a sequence of at least a subset of the plurality of game and/or simulation states with at least one of: a maximum sum of distances between constituent game and/or simulation states of at least the subset and corresponding closest game and/or simulation states of the plurality of game and/or simulation states, and a maximized sum of novelty scores associated with the constituent game and/or simulation states of at least the subset, and
optimize user experience of the virtual environment associated with the gaming and/or simulation application across a plurality of users in accordance with iteratively balancing parameters related to specific configurations of the virtual environment associated with the gaming and/or simulation application based on full simulations of the game and/or simulation by the plurality of agents, the parameters related to at least some of the plurality of game and/or simulation states.

9. The data processing device of claim 8, wherein the processor further executes the instructions associated with the at least one gaming and/or simulation algorithm to, for each constituent game and/or simulation state in each path sequence formed with the plurality of game and/or simulation states comprising the path with the maximum sum of distances,
calculate a distance to a closest game and/or simulation state of the plurality of game and/or simulation states among a set of game and/or simulation states already defined and stored in the memory and subsequent constituent game and/or simulation states in the each path sequence, and
score the each path sequence with each of the calculated distance to the closest game and/or simulation state summed for all constituent game and/or simulation states therein.

10. The data processing device of claim 9, wherein the processor executes the instructions associated with the at least one gaming and/or simulation algorithm to:
perform clustering of all the constituent game and/or simulation states for the each path sequence such that each cluster is represented by a representative of the constituent game and/or simulation states and a minimum distance thereof to another cluster, and
determine a global minimum distance between two clusters generated through the clustering.

11. The data processing device of claim 8, wherein the processor executes the instructions associated with the at least one gaming and/or simulation algorithm to compute, as part of iteratively balancing the parameters, a balance factor of a configuration of the specific configurations as
$$1 - \frac{{\sum }_{k}^{R} {\sum }_{i , j , i \neq j} \vert {se}_{k}^{i} - {se}_{k}^{j} \vert}{R * {(}_{2}^{p} )} ,$$
wherein R denotes a number of the full simulations of the game and/or simulation, k=1.. R, p denotes a number of the plurality of agents, and
$${se}_{k}^{i} ∈ [ - 1 , 1 ] and {se}_{k}^{j} ∈ [ - 1 , 1 ]$$
denote game outcomes arrived at by the i^{th} and the j^{th} agent in the k^{th} full simulation.

12. The data processing device of claim 8, wherein the processor further executes instructions associated with the gaming and/or simulation algorithm to determine, as part of iteratively balancing the parameters, a candidate for a next parameter of each parameter of the parameters in accordance with
$$v *= {argmax}_{i} B ( {v}_{i} ) + \sqrt{\frac{2 ln ( {n}_{i} )}{N}} ,$$
wherein v* denotes a value of the each parameter, vᵢ denotes a candidate value for selection, B denotes an average balance coefficient involving the each parameter, which is computed over multiple iterations for which the candidate value vᵢ is set, nᵢ denotes the iterations in which the candidate value vᵢ is selected, N denotes a number of iterations thus far, and argmax is a function that returns the index i at which B(vᵢ) is maximum.

13. The data processing device of claim 8, wherein the at least one gaming and/or simulation algorithm is at least one of: an AI algorithm, a clustering algorithm and a non-AI algorithm.

14. A computing system comprising:
a data processing device comprising instructions associated with at least one gaming and/or simulation algorithm stored therein; and
at least one other data processing device communicatively coupled to the data processing device,
wherein the data processing device executes the instructions associated with the at least one gaming and/or simulation algorithm to:
at least one of: initialize and refine a plurality of game and/or simulation states associated with a virtual environment offered by a gaming and/or simulation application in accordance with executing at least one of: a binary executable and a game and/or simulation associated with the gaming and/or simulation application multiple times, the at least one of: the initialization and the refinement utilizing configuration information associated with the game and/or the simulation therefor,
automatically control exploration of a space associated with the plurality of game and/or simulation states by a plurality of agents interacting with the virtual environment in accordance with determining, for at least one of the plurality of agents to explore, a path comprising a sequence of at least a subset of the plurality of game and/or simulation states with at least one of: a maximum sum of distances between constituent game and/or simulation states of at least the subset and corresponding closest game and/or simulation states of the plurality of game and/or simulation states, and a maximized sum of novelty scores associated with the constituent game and/or simulation states of at least the subset, and
optimize user experience of the virtual environment associated with the gaming and/or simulation application across a plurality of users in accordance with iteratively balancing parameters related to specific configurations of the virtual environment associated with the gaming and/or simulation application based on full simulations of the game and/or simulation by the plurality of agents, the parameters related to at least some of the plurality of game and/or simulation states.

15. The computing system of claim 14, wherein the data processing device further executes the instructions associated with the at least one gaming and/or simulation algorithm to, for each constituent game and/or simulation state in each path sequence formed with the plurality of game and/or simulation states comprising the path with the maximum sum of distances,
calculate a distance to a closest game and/or simulation state of the plurality of game and/or simulation states among a set of game and/or simulation states already defined and stored in the memory and subsequent constituent game and/or simulation states in the each path sequence, and
score the each path sequence with each of the calculated distance to the closest game and/or simulation state summed for all constituent game and/or simulation states therein.

16. The computing system of claim 15, wherein the data processing device executes the instructions associated with the at least one gaming and/or simulation algorithm to:
perform clustering of all the constituent game and/or simulation states for the each path sequence such that each cluster is represented by a representative of the constituent game and/or simulation states and a minimum distance thereof to another cluster, and
determine a global minimum distance between two clusters generated through the clustering.

17. The computing system of claim 14, wherein the data processing device executes the instructions associated with the at least one gaming and/or simulation algorithm to compute, as part of iteratively balancing the parameters, a balance factor of a configuration of the specific configurations as
$$1 - \frac{{\sum }_{k}^{R} {\sum }_{i , j , i \neq j} \vert {se}_{k}^{i} - {se}_{k}^{j} \vert}{R * {(}_{2}^{p} )} ,$$
wherein R denotes a number of the full simulations of the game and/or simulation, k=1.. R, p denotes a number of the plurality of agents, and
$${se}_{k}^{i} ∈ [ - 1 , 1 ] and {se}_{k}^{j} ∈ [ - 1 , 1 ]$$
denote game outcomes arrived at by the i^{th} and the j^{th} agent in the k^{th} full simulation.

18. The computing system of claim 14, wherein the data processing device further executes instructions associated with the gaming and/or simulation algorithm to determine, as part of iteratively balancing the parameters, a candidate for a next parameter of each parameter of the parameters in accordance with
$$v *= {argmax}_{i} B ( {v}_{i} ) + \sqrt{\frac{2 ln ( {n}_{i} )}{N}} ,$$
wherein v* denotes a value of the each parameter, vᵢ denotes a candidate value for selection, B denotes an average balance coefficient involving the each parameter, which is computed over multiple iterations for which the candidate value vᵢ is set, nᵢ denotes the iterations in which the candidate value vᵢ is selected, N denotes a number of iterations thus far, and argmax is a function that returns the index i at which B(vᵢ) is maximum.

19. The computing system of claim 14, where the at least one gaming and/or simulation algorithm is at least one of: an AI algorithm, a clustering algorithm and a non-AI algorithm.

20. The computing system of claim 14, wherein the plurality of agents executes the full simulations of the game and/or the simulation on at least one of: the data processing device and the at least one other data processing device communicatively coupled to the data processing device.
